(19) United States
(12) Patent Application Publication
(10) Pub. No.: US 2023/0316212 A1
(43) Pub. Date: Oct. 5, 2023

(54) PACKAGE IDENTIFICATION USING MULTIPLE SIGNALS

(71) Applicant: United Parcel Service of America, Inc., Atlanta, GA (US)

(72) Inventors: Julio Gil, Veldhoven (NL); Patrick Wall, Atlanta, GA (US)

(21) Appl. No.: 17/707,529

(22) Filed: Mar. 29, 2022

(51) Int. Cl. G06Q 10/08

(52) U.S. Cl. CPC G06Q 10/083

(57) ABSTRACT

The present disclosure is directed, in part, to identifying packages using existing sensors and tags present in items in a package. Various embodiments associate tags or sensors from a package with the package and compare signals from the tags and sensors read at a different time to identify the package using associated tags and sensors.

### BACKGROUND

Everyday millions of items and packages and/or parcels are shipped around the world. Picking up packages and delivering the packages is a small part of the shipping process. A bigger and more complicated part of the shipping process is sorting and tracking the packages via various scanning, reader, and computing system technologies. The packages are separated and organized at different steps during the shipping process based on conventional bar codes and labels that are placed on the packages, x-rays, cameras and the like. Such scanners and readers read these bar codes and labels, usually automatically, to read the codes and retrieve information. Information is then entered into the computer system that allows users to get real-time updates on where the packages are and the status of the package delivery. These labels also help the user determine where the packages need to go and by which method. When the packages are in transit and are removed from the vehicle, airplane, drone, ship, or the like, the packages are again scanned or read and placed in different conveyors with labels facing up so that the computers can scan and read the labels and keep track of the package.

Existing technologies, such as the scanners, readers, and computer systems described above, have various shortcomings because they rely on labels fixed on the packages. If the labels are not immediately readable, scanners or readers cannot scan the labels. Existing technologies also do not rely on adding new, specific labels to the package or parcel rather than utilizing existing tags (such as Radio Frequency Identification (RFID) tags), sensors, or other elements present in or on any contents or items within a package, on the package itself, and/or otherwise embedded within the package to identify and track the package.

### SUMMARY

Aspects of the present disclosure are directed, in part, to utilize signals or tags present in a package to identify packages. Particular embodiments include a signal reading apparatus that are designed to read signals or tags. The embodiments further include packages that include one or more items or one or more objects that may include associated tags or sensors. The embodiments further include computing devices that communicate with the signal reading apparatus. These computing device can include computer processors and a memory comprising instructions that when executed by one or more computer processors cause the one or more computer processors to, at a first time, receive information from the sensors or tags present in the package. For example, the information can include signals from the sensors or tags present in the package. The computer processors can also associate a portion of the signals from the sensors and tags detected to the package present in the area. In particular embodiments, the package can be identified at a second time when the signal reading apparatus detects or reads signals from sensors or tags from the package at a second time and compares a portion of the signals with the associated signals form sensors or tags at the first time. The package can be identified if there is an overlap between the portion of signals from sensors or tag detected or read at the second time and portion of associated signals from sensor or tags.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached figures, which are intended to be exemplary and non-limiting, wherein:

FIG. 1 is a diagram of an existing system 100 is provided to identify packages, according to some embodiments.

FIG. 2 is a diagram of a system 200 showing aspects of an example system suitable for implementing some embodiments of the disclosure.

FIG. 3 is a flow diagram of an example process 300 for identifying packages according to some embodiments.

FIG. 4 is a flow diagram of an example process 400 for identifying packages using labels and RFID tags, according to some embodiments.

FIG. 5 is a flow diagram of an example process 500 for encoding labels for packages using RFID tags associated with the package, according to some embodiments.

FIG. 6 is a flow diagram of an example process 600 for using overlap algorithms to identify a package based on the RFID tags present inside the package, according to some embodiments.

FIG. 7 is a flow diagram of an example process 700 for building a map of a facility based on the recorded locations of the package, according to some embodiments.

FIG. 8 is a flow diagram of an example process 800 for building a map of a facility based on the recorded locations of the package, according to some embodiments.

FIG. 9 is a diagram a diagram illustrating an exemplary embodiment of a system for scanning packages.

FIG. 10A is a diagram illustrating an exemplary package containing items.

FIG. 10B is a diagram illustrating an exemplary system including multiple packages.

FIG. 11 is a schematic diagram of an example computing environment in which aspects of the present disclosure are employed in, according to some embodiments.

FIG. 12 is a block diagram of an analysis computing entity of FIG. 10, according to some embodiments.

FIG. 13 is a block diagram of a computing entity of FIG. 10, according to some embodiments.

### DETAILED DESCRIPTION

The technology of the present disclosure is described with specificity herein to meet statutory requirements. However, the description itself is not intended to limit the scope of this patent. Rather, it is contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various embodiments of the technology described herein provide a configuration to identify packages based on signals detected from a package such as signals from RFID tags on items contained within such packages. These packages can be identified in shipping facilities, transportation facilities, before or after the package is transported, during deliver routes and the like.

Each package going through the shipping process can contain multiple contents or items. As technologies progress, different kinds of sensors and/or tags are being embedded in items or contents in the packages, attached to the items or attached to contents in the packages, embedded or attached to the packaging of the items, on product containers that hold the items, attached or embedded in packages or parcels used to transport multiple items, attached to the paper tags of the items or any other tags that may exist for the items, or embedded or attached to any material present or contained in or on the package or the package itself. These sensors and tags are included for inventory control, providing data to companies, and the like. One such tags that items contain are radio-frequency identification (RFID) tags. Some tags can be passive or active. In passive systems, RFID readers emit radio waves and receive signals back from the RFID tags that communicate their identity to the readers. These tags can store a variety of information such as a serial number of a vast amount of data. In active systems, the RFID tags broadcast their own signals.

Existing technologies fail to employ intelligent functionality that use sensors or tags included in the items in order to identify packages and keep track of packages during the shipping process. It is very important for the systems during the shipping process to identify the packages because through every step of the shipping process, the packages are continuously identified and routed to the correct path in order to reach its destination. For example, when the packages are being transported, the system identifies the package, determines the delivery location, determines the best method of transport and directs the package to that transport area. For example, if the package needs to be transported by a drone, the system will direct the package to the conveyor belt of car or cart of wagon that is delivering the packages to the drone for transportation. If the package has been transported, when the package is removed from the transport, the package is identified to determine where it should go next. It is then directed to a car, truck, ship, vehicle, drone, plane for further transport or it is transported to a shipping facilities for further sorting. In the shipping facility the system identifies packages to determine which conveyor path to push the package through based on the delivery location. The identity of the package also helps the system determine what infrastructure is needed to push the package through the conveyor system. For example, if the package is identified, the system can determine it is a heavy package and would need extra infrastructure to push the package through the system or it would need a robot to pick up the package and transport it to a waiting truck and place the package in a certain location in the truck to better assist the driver during delivery.

Existing technologies typically use convention bar codes and labels that are placed on the packages, x-rays, cameras and the like to identify the package. However, if the package is placed incorrectly so that the label is not facing the scanner that reads the label or the label tore or got damaged, then the existing technologies need human intervention to fix the problem in order to identify the label. This can result in an increase in cost to deliver the package and requires continuous human monitoring and intervention. In some cases, multiple packages are delivered using the same labels that the systems do not pick up on and deliver multiple packages on the same label. Existing technologies fail to use existing signals already present in a package to identify the package and instead of using conventional bar codes and labels on the package to identify a package that can lead to various inaccuracies and increase in time, cost and the like.

Various embodiments of the present disclosure provide one or more technical solutions to these, and other, technical problems described above. For instance, particular embodiments improve identification of packages using already existing sensors and tags in the items that are contained in the package (and in some embodiments, on a surface of the package itself). Various embodiments capture or map out the interior building of a shipping facility and also map out different conveyor routes present in the facility using already present sensors and tags in the items present in the package or via scanning apparatuses located throughout the facility or scanning apparatuses located on robots or drones or the like in the facility. Furthermore, particular embodiments, unlike existing technologies, do not rely on conventional bar codes and labels that are placed on the packages, x-rays, cameras and the like to identify packages, which can be unreliable. Furthermore, in various embodiments described herein labels and bar codes do not need to be placed in the correct place for the package to be scanned. This is at least partially because certain tags, such as RFID tags, can be read from a variety of angles, positions, and distances and so such tags need not be directly oriented up or any other manner required by existing technologies, such as scanners. Moreover, particular embodiments do not require any tags to be located on a surface of the package. In some instances, logistics entities may use their own labels or sensors on the package surface to identify a package. However, because tags located within the package (such as on items), can be used to identify packages, such package surface tags may not be needed at all.

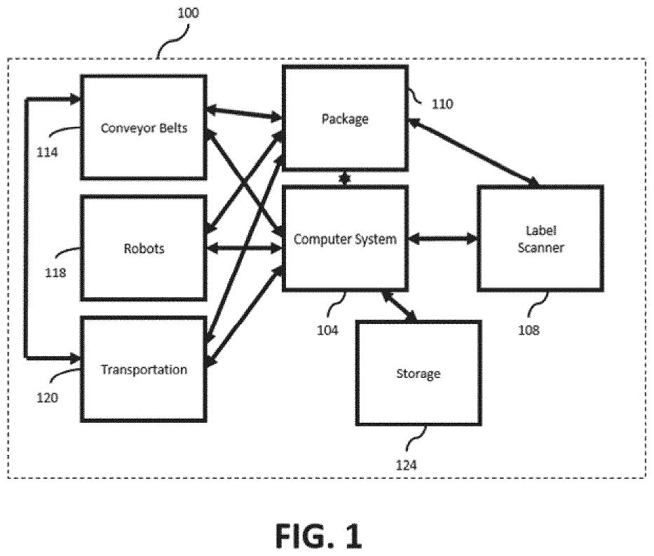

Turning now to the figures, FIG. 1 is a diagram of an existing system 100 is provided to identify packages, according to some embodiments. As illustrated in FIG. 1, the system includes conveyor belts 114, robots 118, and transportation 120 to assist with movement of a package 110 through the routing and sorting process in a shipping process. The system includes a label scanner 108 that scans labels from the package 110 as it moves along either through the conveyor belts 114 or through a transport 120 such as a drone, car, truck, ship, plane and the like. Label scanner 108 can also scan labels as robots 118 are assisting with the package 110 movement through the shipping process. The system 100 further includes a computer system 104 that includes at least one computing device having at least one processor and at least one computer readable storage medium), and/or the computer readable medium as described herein may perform or be caused to perform the processes 300, 400, 500, 600, 700, 800 or any other functionality described herein. The computer system 104 communicates with the label scanner 108 to receive information of the label scanned from the package 110. The computer system 104 uses the storage 124 storage 124 (e.g., RAM, a disk array, or a relational database) to identify the package 110 from the information, identify the location of delivery for the package 110, identify the type and size of the package 110 and the like. Based on this information, the computer system 104 determines the path the package will take through the conveyor belts 114 or using robots 118 or sending to a waiting transportation 120. The computer system 104 determines the correct conveyor belts 114 that will be used to direct the path of the package 110, the robots 118 that will be used to transport the package 110 to a particular location or particular transportation and the like. The computer system 104 updates information about the package 110 in the storage 124 such as the updated location of the package 110 real-time.

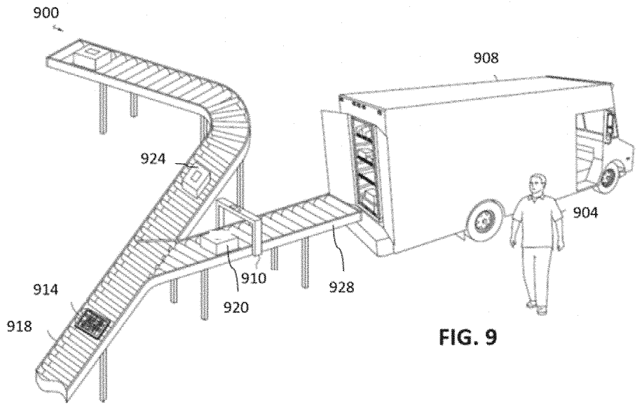

Referring now to FIG. 9, a diagram illustrating an exemplary embodiment of a system 900 for scanning packages. In one example, a package 920 that needs to be transported or shipped arrives at a sorting facility. In this example, the package 920 is retrieved from a method of transportation such as a truck 908. A user 904 of the system 900 may or may not be present in the facility. In one example, the package 920, 924 is directed through the conveyor belts onto the transportation vehicle 908. In another example, the package 920, 924 is retrieved from the transportation vehicle 908 and based on the label on the package 920, 924 is directed to different conveyor belts to sort the package 920, 924 further. In one example, the label of the package 920, 924 can include sensors and/or tags. In another example, the label of the package 920 does not include sensors and/or tags. In FIG. 9, package 924 was retrieved from the vehicle 908 and placed on conveyor belts 928. The package 924 passed under a scanner 910. The scanner 910 was able to scan the label on the package 924 and determine which conveyor belt to place it onto next or which path the package 924 should follow based on the information provided in the label on the package 924. It should be understood that the labels can be scanned or read or detected using any signal detection apparatuses using any technology that can be used to detect or scan or read any signals such as optical, barcode reading, OCR, or the like. An example of the label on the package 924 could be the destination of the package 924, the weight of the package 924, the dimensions of the package 924, the kind of package 924, the items contained in the package 924 or the like. In this example, another package 920 is then retrieved from the transportation vehicle 908. However, due to a mistake such as the box being placed on the package so that the label faces away from the scanner 910 or the label on the package 920 being torn or lost or the like, the scanner 910 is unable to scan the package 920 and retrieve information from the package 920. At this point, some assistance may be needed in terms of robots or a human intervention 904 to rotate the package 920 to locate the label on the package 920.

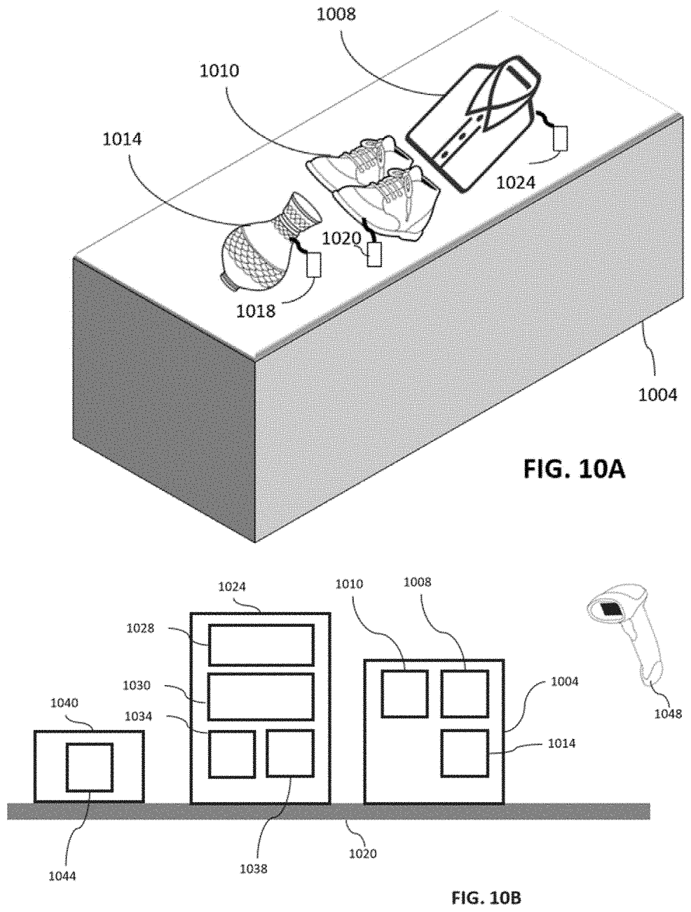

Referring now to FIG. 10A, a diagram illustrating an exemplary package containing items. In this example, a package 1004 is a box that contains items such as a shirt 1008, a pair of shoes 1010, and a vase 1014. In this example, the items include some kind of sensors or tags that are either attached to the item in some manner or embedded into the item. For example, the company shipping the shirt 1008 would put tags 1024 on the shirt for inventory purposes, identification of item, item details such as the color of shirt 1008, size or the like, further item details such as any customization information, identification of person the shirt 1008 is being shipped to or the like. It is understood that any other type of information can be included in the tags or sensors. The other items present in the package are a pair of shoes 1010 onto which is attached another tag 1020 and a vase 1014 onto which a tag 1018 is embedded. In this example, these tags 1024, 1020, 1018 can be used to identify the package 1004. These can be passive tags that do not broadcast signals or active tags that broadcast signals or tags that broadcast signals when it detects it is in a certain location or if it senses sensors nearby or through any other predetermined time or condition. It is understood that any mechanism that is embedded or attached to the items can be used to identify the package 1004. In one example, a signal reader is able to read the tags 1024, 1020, 1018 from package 1004. Then the system can determine that the tags 1024, 1030, and 1018 belong in the package 1004. This can be used to identify the package 1004 at a later time. In one example, the system can identify the package 1004 based on the information from the signals and/or tags. In another example, the system can identify the package 1004 from the strength of the signals. For example, from package 1004, the system detects two signals, three signals, one weakened and two amplified. This can depend on how far the tags or sensors that are emitting the signals are inside the package 1004 and where they are placed in the package 1004. The system can also determine the distance between the signals in the package and can identify the package 1004 from the distance between the different signals coming from the package 1004. For example, one signal might be in one corner of the package that is coming from a tag in an item in the package 1004. Another signal might be coming from an old label stuck on the package that is being reused and the old label is emitting signals from a certain distance from signal coming from the corner of the package. For example, some of the signals detected in the package 1004 might not be associated with the contents of the shipment, but may be from old labels or tags on reused cardboard boxes or packages 1004 or partial readings from damaged tags. Based on the distance, strength or the signals, or information from the signals, or other data or characteristics of the signals and minute variations that may allow to distinguish the package 1004 from other shipments or packages or a combination, the system can identify the package 1004 at a later time. In another example, the signal reader 1048 reads any signals from the package 1004 such as signals from items in the package 1004, tags attached to the items in the package 1004, tags or labels attached to packaging inside or on the package 1004, an old label from a reused package 1004, old labels from reused cardboard box, partial readings from damaged tags, a combination of different signals in the package, and the like and the system then can identify the package 1004 at a later time. In one example, the system uses a combined information of all signals coming from the package 1004 to create a unique wireless signature that can be used to identify the package 1004 at a later time.

Referring now to FIG. 10B, a diagram illustrating an exemplary system including multiple packages. In this example, the package 1004 that contains the shirt 1008 including a tag 1024, shoes 1010 including a tag 1020, and vase 1010 including a tag 1018 is being transported onto a conveyor belt 1020. It should be understood that other method of transporting packages can be used. In this example there are other packages that are also being transported on the conveyor belt. In one example, the package 1038 includes items 1028, 1030, 1034, and 1038 that have different tags and the package 1040 includes one item 1044 that includes a different tag. In one example, the signal reader 1048 reads tags from items vase 1014 and shoes 1010. Even through the signal reader 1048 was not able to read all the tags from the package 1014, it can identify the package 1014 as the package 1004 containing those items 1008, 1010, 1014 because those items 1008, 1010, and 1014 are associated with the package 1004. For example, the system can determine it is the same package depending on location factors such as the area where it was last scanned and the present area or the time between the last scan and the present scan or the conveyor belts or the system that was last used when it was being transported compared to where the package is on presently. For example, if the items 1008, 1010, and 1014 on the package 1004 was last scanned 1048 on a conveyor belt close to the transportation vehicle and now the items 1010 and 1014 of the package 1004 are scanned 1048 on a conveyor belt on a path from the transportation vehicle to another sorting location, the system can determine it is the same package 1004 because it contains some of the items associated with the package 1004 and it is close to where it was last scanned or the time between the scan, a combination of location or time, or the like.

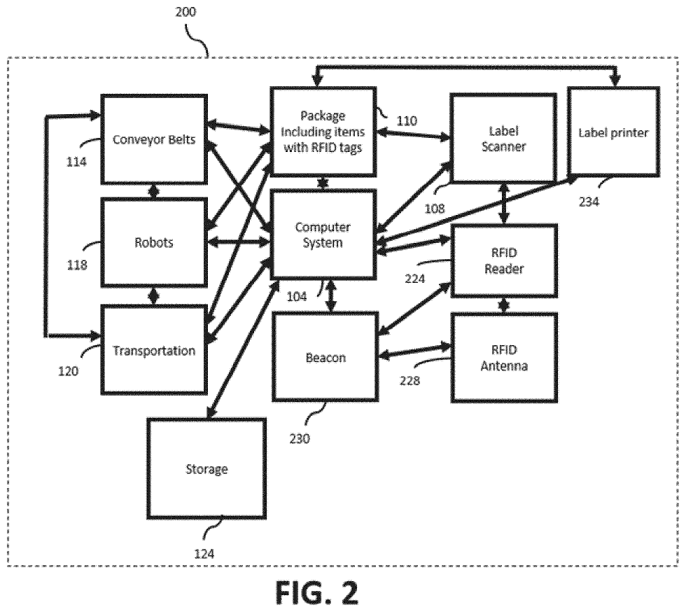

Referring now to FIG. 2, a diagram of a system 200 showing aspects of an example system suitable for implementing some embodiments of the disclosure is provided. In this example, RFID tags present in the package are used to identify the package 110. However, it should be understood that as technologies advance and more sensors and intelligent tags are embedded and placed along with items, embedded in items, attached to the items, or attached to the tags of the items can be used in the same manner to identify packages. As such, system 200 represents only one example of a suitable system to identify packages 110. Other arrangements and elements can be used in addition to or instead of those shown, and some elements may be omitted altogether for the sake of clarity. Further, many of the elements described herein are functional entities that may be implemented as discrete or distributed components or in conjunction with other components, and in any suitable combination and location. For example, some or each of the components of the system may be located within a single computing device (e.g., the computing entity 10 or the analysis computing entity 05 of FIG. 9). Alternatively, some or each of the components may be distributed among various computing devices, such as in a distributed cloud computing environment. In some embodiments, the components of the system 200 are distributed among the one or more computing entities 10 and/or the one or more analysis computing entities 05 of FIG. 9.

The system 200 includes network 210, which is described in connection to FIG. 9, and which communicatively couples components of system 200, including the conveyor belts 114, robots 118, transportation 120, storage 124 (e.g., RAM, a disk array, or a relational database). The components of the system 200 may be embodied as a set of compiled computer instructions or functions, program modules, computer software services, logic gates, or an arrangement of processes carried out on one or more computer systems.

The system 200 generally operates to identify the package 110 using already existing sensors and tags present in the items within the package 110. For example, in some items in the package, RFID tags 110 are attached to those items for inventory or other purposes. Some of these antenna contain chips that contain memory which stores the products unique code and other variable information that can be read and tracked by RFID readers 224. Passive tags do not have an active transmitter. The RFID readers 224 communicate with the tags 110 using RFID antennas 228. In one example, the package 110 containing one or more RFID tags 110 passes through a scanning area where the RFID reader 224 is present. The RFID readers 224 couples with the RFID tags 110 and reads data from the RFID tags 110 and then translate the data into a readable format. This data can then be provided to the computer system 104 and stored in the storage 124 to associate the data and tag information with the package 110. In other examples, other sensors and tags can be used and other readers and/or antenna can be used to communicate with the sensors and tags in packages. For example, a combination of different readers can be used to read RFID tags and other technology sensors and tags present inside or on the package 110, present inside or on items in the package 11, or present inside or on packaging of the items inside the package 110. In this example RFID readers 224 are used, but it understood that any type of signal detection apparatuses can be used to detect or scan or read different types of signals or a combination of signals from the package. Some RFID tags 110 are passive and others are active. In another example, the reading apparatuses can either read or detect signals from sensor or tags present in the package 110. In another example, the reading apparatuses can either automatically detect signals from a package 110 or automatically read signals from the package 110, or communicate with the sensors or tags in the package to read signals from the package 110. These sensors or tags can be present anywhere inside or attached to the package 110, inside or attached to the items in the package 110, inside or attached to packaging of the items in the package 110, attached to the paper tags of the items or any other tags that may exist for the items, or embedded or attached to any material present or contained in or on the package or the package itself, or the like.

In some embodiments, the system includes signal reading apparatus 230 or other readers that can scan an area for multiple signals and sensors. For example, signal reading apparatus 230 can be placed in different locations of a shipping facility building to scan packages 110 that are being transported through the facility. These signal reading apparatus 230 can scan RFID tags and other tags and sensors or combination of different signals present inside the package from the items or the package 110 using different technologies. The signal reading apparatus 230 can receive information from the signals from the package 110 such as the type of signal (weakened, distorted, amplified and the like) or the distance of the signals in the package 110 and provide information to the computer system 104 regarding the package 110. In another example, system can use beacons present to determine the location of the package. The computer system 104 can update the storage 124 with real-time update of the package 110 that includes location update, delivery update, items contained in the package and the like. The computer system 104 can use the information being provided by the signal reading apparatus 230, the RFID readers 224, and the label scanner 108 to map the building of the facility, the conveyor arrangement, the movement and location of robots 118, and/or the movement and location of transportation 120. In one example, when the sensor reader apparatuses or RFID readers scan the sensors and/or tags present the package and identify the package based on the sensors and/or tags, the computer system 104 can utilize beacons present in the environment to determine the location of the package after the package is identified. This will assist the system 104 to follow the package through a facility or shipping process.

In some embodiments, the system 200 includes label scanner 108 that can scan the labels of the packages It should be understood that the labels can be scanned or read or detected using any signal detection apparatuses using any technology that can be used to detect or scan or read any signals such as optical, barcode reading, OCR, or the like. The label scanner can be used to retrieve identification of the package 110 and then associate the scanned RFID tags or other tags and sensors from the items in the package 110 with the package 110. For example, the label scanner 108 can scan a package that is heading to Kansas City, MO. The RFID scanner scans the items in the packages and identifies item 1, item 2, and item 3 contained in the package. The computer system 104 can use this information to associate this package 110 heading to Kansas City, MO with item 1, item 2, and item 3. The computer system 104 can store this information in the storage 124.

In some embodiments, the 200 further includes a label printer 234 that can be used to print labels for the packages. In one example, when the computer system 200 has identified the RFID tags present in a package 110 or other tags and sensor present in the package 110, it can send that data to the label printer 234 to print a label for the package that includes the encoded information. When this label is then read by a label scanner 108, the label scanner 108 can retrieve the items and RFID tags associated with the package 110 based on the encoded label.

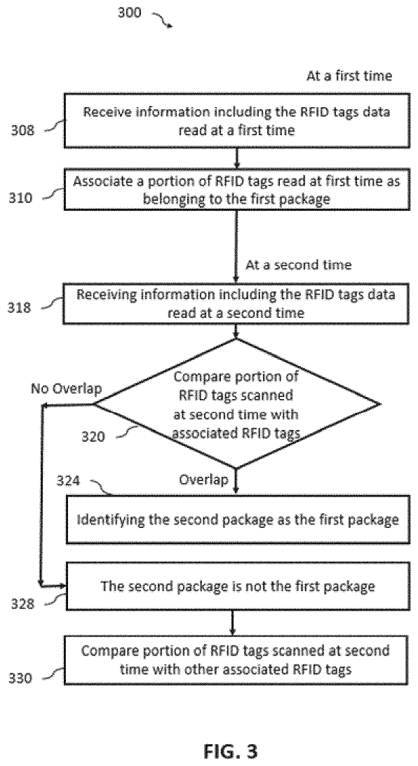

FIG. 3 is a flow diagram of an example process 300 for identifying packages according to some embodiments. In this example, existing RFID tags in the items in the package 110 are used to identify the package 110. However, other sensors and/or tags embedded in items or attached it items can be used in a similar manner to identify packages 110. The process 300 (and/or any of the functionality described herein) may be performed by processing logic that comprises hardware (e.g., circuitry, dedicated logic, programmable logic, microcode, etc.), software (e.g., instructions run on a processor to perform hardware simulation), firmware, or a combination thereof. Although particular blocks described in this disclosure are referenced in a particular order at a particular quantity, it is understood that any block may occur substantially parallel with or before or after any other block. Further, more (or fewer) blocks may exist than illustrated. Added blocks may include blocks that embody any functionality described herein. The computer-implemented method, the computer system 104 (that includes at least one computing device having at least one processor and at least one computer readable storage medium), and/or the computer readable medium as described herein may perform or be caused to perform the process 300 or any other functionality described herein.

In some embodiments, a package 110 passes through a scanning area where an RFID reader 224 can read RFID tags in items in the package 110 at an initial time (first time). In one example, an RFID reader 224 communicates with an RFID antenna 228 and couples with RFID tags present. The RFID reader 224 reads data from the RFID tag and translates the data to a readable format and provides that to the computer system 104. Per block 308 and 310, the computer system 104 receives the information of the RFID tags read and associates the RFID tags read at that time as belonging to the package 110 that passed through the scanning area. In another example, the computer system 104 can associate only a portion of the RFID tags that were read at that time as belonging to the package 110. The computer system 104 stores the information in data associating all or a portion of the RFID tags read as belonging to one package in storage 124. If the computer system 104 receives data of the label of the package from the label scanner 108, the computer system 104 can associate the complete set or a portion of the RFID tags read as belonging to that particular label. The computer system 104 can store this information in storage 124. It should be understood that while an RFID reader 224 is used in this example, any technology can be used to detect signals from a package 110 such as optical technologies or barcode reading technologies or OCR or the like.

At a later time frame than the first time (second time), a RFID reader 224 reads RFID tags from the package and provides the read RFID tag's data to the computer system 104. Per block 318, the computer system 104 receives the information from the RFID reader 224 that includes the RFID tag data read at the second time. Per block 320, the computer system 104 then compares the RFID tags scanned at the second time with all the associated RFID tags. For example, the computer system 104 uses storage 124 to retrieve associated RFID tags and compares the RFID tags read at a second time with the associated RFID tags. If a portion of the RFID tags read at a second time overlaps with a portion of the associated RFID tags, then, per block 324 the computer system 104 can identify the package at the second time as the first package it saw at the first time. For example, if at block 308, the computer system 104 receives RFID tag data for item 1, item 2, and item 3 at a first time, it will associate item 1, item 2, and item 3 as belonging to the same package. Per block 320, at a later time (second time), if the computer system 104 receives RFID tag data for only item 1 and item 3, it will compare that to the associated RFID tag data. In one example, the computer system 324 may use algorithms such as on threshold overlap algorithms, such as Jaccard Index to determine if there is an overlap in the identifications. In another example, other algorithms or comparisons can be made such as, in one example, using computations and permutations to determine possible pairs of the associated RFID signals and compare that to the RFID signals read at a second time. In this example, since the computer system 104 can determine that Item 1 and Item 3 is included in the same package (as Item 1, Item 2, and Item 3), it can conclude this is the package it had scanned at the first time. This information can be updated in the storage 124 that includes the location of the package, the time the package was scanned using tags, labels, or other methods, the items in the package, which items are being read and which are not being read and the like.

Per block 328, if there is no overlap between the RFID tags read at the second time and associated RFID tags with the first package, then the computer system 104 determines that the second package does not match the first package. Per block 330, in one example, the computer system 104 can search other associated RFID tags associated with other packages or store information about the new RFID tags read and associate them with a new package. For example, if at a second time, the computer system 104 receives information about item 5, item 6, and item 7, the computer system 104 will determine that no portion of item 5, item 6, and item 7 overlap with already associated RFID tags (item 1, item 2, and item 3) that have been read before. The computer system can review other associated RFID tags to determine if they belong to a different package. If they don't belong to a different package, the computer system 104 can store the tags associated with item 5, item 6, and item 7 as belonging to a third package. In another example, the computer system 104 is able to identify the package 110 because of the combination of signals within the set of packages or shipments at a time. The combination of signals from one package may not be unique because they may be found on a different package the same day or same week or same month. The computer system 104 may trigger the addition of a new tag with a unique identifier to ensure two packages with same combination of signals can be differentiated. In one example, if two signals are detected from package 110 such as one from an old label on the package 110 and one weakened signal coming from a damaged tag inside the package 110. That combination of signals may not be universally unique and may be present in another package at another time. But if the combination of the signal from the old label and the weakened signals detected from the package 110 is unique within the set of shipments at a second time, then the computer system 104 can identify the package 110 at the second time. In one example, the computer system 104 identifies the packages based on information from the tags or sensors or labels detected in the package and other information from the signals such as the strength of the signals or other minute variations of the signals in order to distinguish the package 110 from the other shipments or packages 110 at the time.

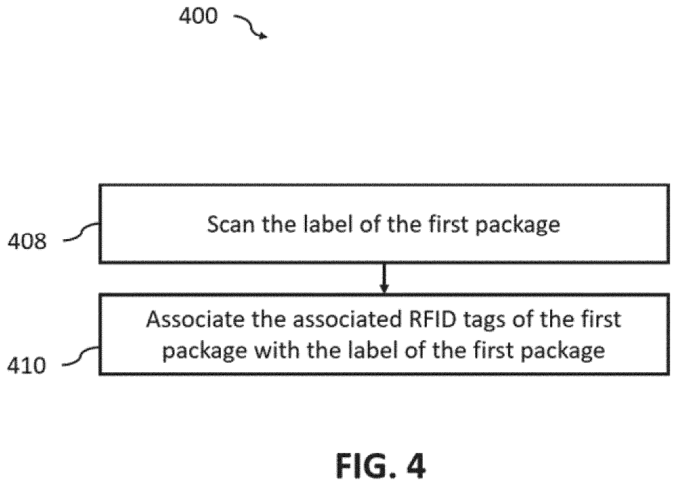

FIG. 4 is a flow diagram of an example process 400 for identifying packages using labels and RFID tags, according to some embodiments. It should be understood that the packages can be identified using any signals detected from the package 110 such as signals from labels and any other sensors and/or tags included or embedded in the items or the tags of the items in the package 110. In one example, packages 110 can be identified from information detected from the signals, the signal strength, distance of the signals in the package 110, or information from the signals, or other data or characteristics of the signals and minute variations that may allow to distinguish the package 1004 from other shipments or packages or a combination of these. Per blocks 408 and 410, in one example, when the RFID tags are read, the computer system 104 can scan the label of the package if possible and associate the RFID tags of the package read with the label that has been scanned. This information can be stored in the storage 124 so that the label of the package is always associated with those particular RFID tags that were read along with the package. It should be understood that the labels can be scanned or read or detected using any signal detection apparatuses using any technology that can be used to detect or scan or read any signals such as optical, barcode reading, OCR, or the like.

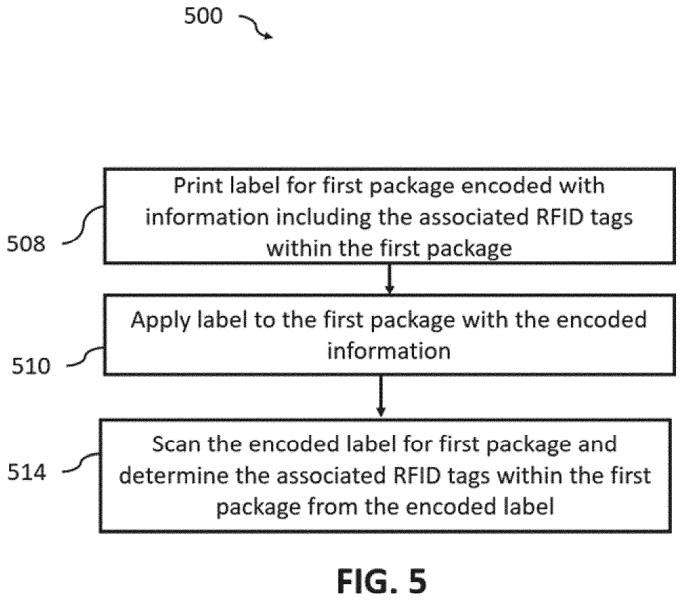

FIG. 5 is a flow diagram of an example process 500 for encoding labels for packages using RFID tags associated with the package, according to some embodiments. In one example, the package 110 is scanned for RFID tags and data that includes the RFID tags read are associated with the package 110. Per block 508, a label is printed for the package that is encoded with information that includes the RFID tags that are associated with the package 110. Per block 510, the label is applied to the first package. Per block 514, when the encoded label is scanned, the associated RFID tags present in the package can be obtained from the label.

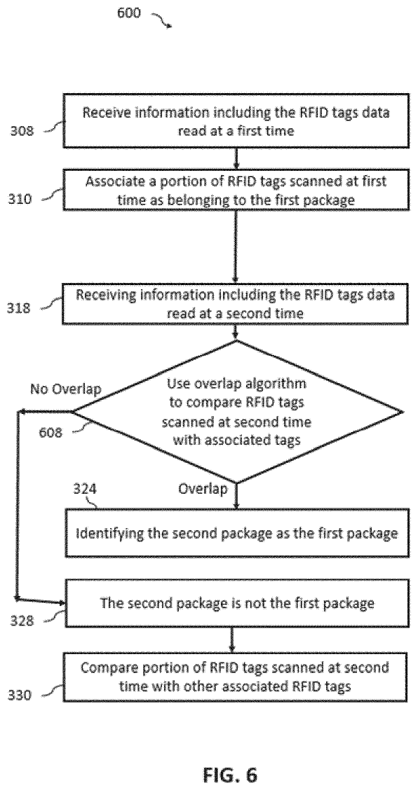

FIG. 6 is a flow diagram of an example process 600 for using overlap algorithms to identify a package based on the RFID tags present inside the package, according to some embodiments. The example process 600 can be used together with example process 300 or any of the other processes discussed herein. Per block 608, the computer system 104 uses threshold overlap algorithms, such as Jaccard Index to determine if there is an overlap in the identifications. In another example, other algorithms or comparisons can be made such as, in one example, using computations and permutations to determine possible pairs of the associated RFID signals and compare that to the RFID signals read at a second time. For example, if an RFID reader reads RFID tags identifying item 1, item 2, and item 3 from a first package at first time. In this example, if we assume that at a later time the first package is right next to a fifth package the RFID reader 124 might read multiple RFID tags such as item 1, item 3, and item 5. Since only item 1 and item 3 belong to the first package and item 5 belongs to the fifth package, the computer system 104 will need to use algorithms such as an overlap algorithm to figure out that item 1 and item 3 belong to the first package and can then identify that the first package is passing through that area.

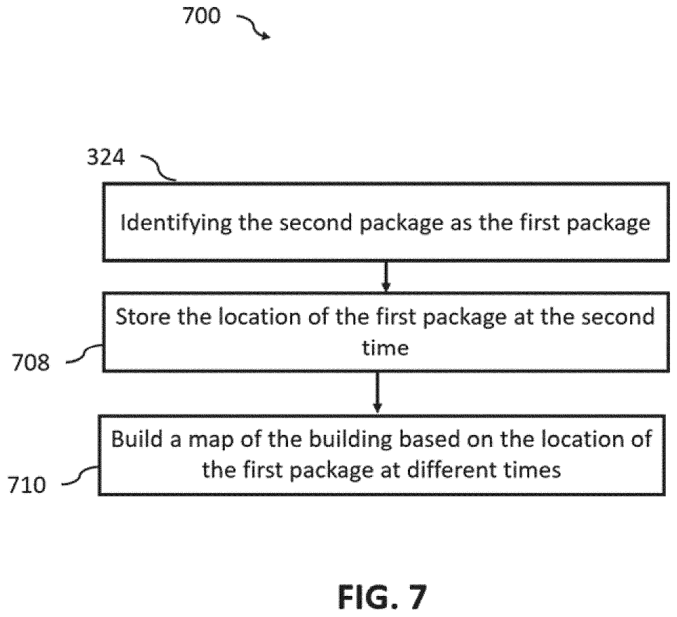

FIG. 7 is a flow diagram of an example process 700 for building a map of a facility based on the recorded locations of the package, according to some embodiments. In one example, the map of the facility can be build based on the RFID tags that are read at different locations. For example, signal reading apparatus 230 that can read signals from different sensor or tags present in the items of the package or on the package itself or other RFID readers 224 can be placed in different location of the facility. Per blocks 324 and 708, these signal reading apparatus 230 and RFID readers 224 can continuously scan RFID signals and determine the associated package that is traveling through the area and store the location of the packages as it moves through the facility. Per block 710, with this information, the map of the facility can be determined.

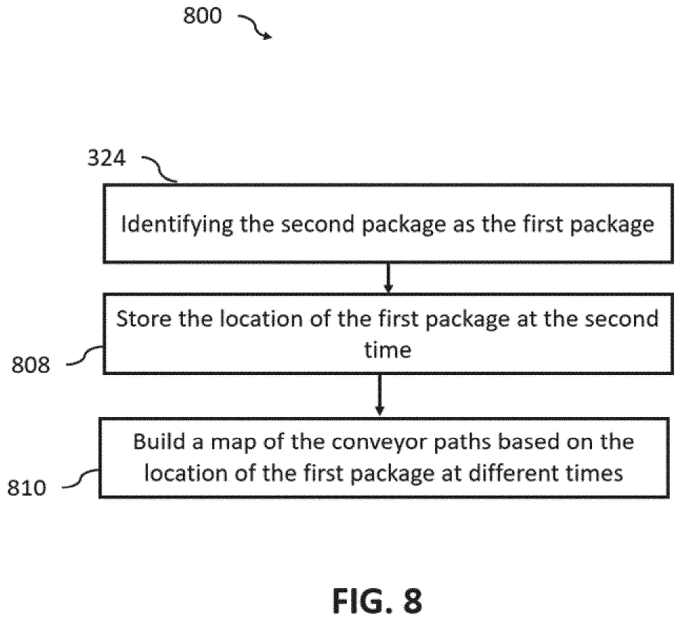

FIG. 8 is a flow diagram of an example process 800 for building a map of a facility based on the recorded locations of the package, according to some embodiments. Some shipping facilities contain multiple conveyor belts to sort and move packages through the facility. In one example, the map of the conveyor belts in the facility can be build based on the RFID tags that are read at different locations. For example, signal reading apparatus 230 or other RFID readers 224 can be placed in different location of the facility. Per blocks 324 and 808, these signal reading apparatus 230 and RFID readers 224 can scan RFID signals and identify the associated package that is traveling through the area and store the location of the packages as it moves through the facility. Per block 810, with this information, the map of the conveyor belts in the facility can be determined.

In one exemplary embodiment, the computer system 104 uses a combination of signals from a package to identify the package. Those signals can come from the sensors or tags embedded or attached to the package that contains items, from paper tags attached to items, from sensors or tags embedded or attached in another manner to the items, from sensors or tags embedded or attached to the packaging around the items, attached to the paper tags of the items or any other tags that may exist for the items, or embedded or attached to any material present or contained in or on the package or the package itself, or the like.

In another exemplary embodiment, the labels of the package can include sensors or tags that emit signals that can be used to identify the package or identify the contents in the package or identify the path that will be used to transport the package or identify characteristics of the package or the items within the package or identify the destination or identify the customer associated with either shipping the package or receiving the package or the like. In another example, sensors or tags can be embedded or inlayed inside a paper. The computer system 104 can print out labels on the paper that will allow the labels to either emit signals or allow a signal reader to read the signals from the label. In one example, since the paper has the embedded sensor or tag, a consumer or user can print out labels at home and attach it to a package or associate the label to a package. For example, if an RFID is inlayed into a precut label paper, a label can be printed and this label has an RFID enabled labels that can be read using a RFID reader. In another example, the sensor or tag that is inlayed or embedded into the paper includes either a generic or a specific serial number. A computer system 104 can rewrite the information in the sensor or tag inlayed and embedded into the paper by using an encoding apparatus or any other apparatus to encode new information into the sensor or tag.

In another exemplary embodiment, different apparatuses can be used to read signals from the package. In one example, a handheld device can be used to read signals from the package. If the handheld device does not have the capability to read signals from the package, an external apparatus can be attached to the handheld device to read a combination of different signals emitted from the package. The handheld device can then use the signals to identify the package. In one example, a handheld device can also be used to encode information in sensors or tags in a package. In one example, if a handheld device does not have the capability to encode signals or tags in the package, an external apparatus can be attached to the handheld device to encode those signals or tags in the package. In one example, a mobile device can be used to read signals from a package or encode information. The mobile device can print out a label in a printer that contains and RFID tag. The mobile device can also encode information onto the RFID tag embedded into the paper. In another example, the handheld device can include external or internal interfaces to receive Near Field Communication (NFC) signals or other signals so that the handheld device can read and use those signals to translate that into information. In one example, this information can be used to encode in the label. In one example, the interfaces will allow different handheld devices to write information or encode information on sensors or tags embedded either in labels or in the package or in the items contained in the package. One example of interfaces can be applications on the phone. Another example of interfaces can be external apparatuses attached to the mobile device that receive or transmit signals for the handheld device.

Accordingly, described herein are various aspects of technology directed to systems and methods for package identification using multiple signals. It is understood that various features, sub-combinations, and modifications of the embodiments described herein are of utility and may be employed in other embodiments without reference to other features or sub-combinations. Moreover, the order and sequences of steps shown in the example flow diagrams are not meant to limit the scope of the present disclosure in any way, and in fact, the steps may occur in a variety of different sequences within embodiments hereof. Such variations and combinations thereof are also contemplated to be within the scope of embodiments of this disclosure.

In some embodiments, a computerized system, such as the computerized system described in any of the embodiments above, comprise at least one computer processor, one or more computer storage media storing computer-useable instructions that, when used by the at least one computer processor, cause the at least one computer processor to perform operations. The operations comprise receiving a first information including first signals from a plurality of RFID tags read at a first time using an RFID reading apparatus in a scanning area when a package is placed in the scanning area. The operations further comprise associating a portion of the first signals detected at the first time as belonging to a first package and determining the identification of the first package at a second time by receiving a second information including second signals from RFID tags from a second package read at a second time using the RFID reading apparatus. The operations further comprise comparing a portion of the second signals detected at the second time with a portion of the first signals and identifying the second package as the first package when there is an overlap between the portion of the second signals detected at the second time and the portion of the first signals.

Advantageously, these and other embodiments, as described herein, improve the way computers operate in terms of computer resource consumption (e.g., CPU, memory, I/O, network latency) and utilizing signals present in the environment to identify and track packages. Because various embodiments are adequately integrated with client applications, they do not require users to manually perform excessive input. Accordingly, when a TCP/IP packet, for example, traverses a network, there are reduced throughput and latency costs because less data is being sent over a computer network. In like manner, there are not as many disk I/O costs (e.g., excess physical read/write head movements on non-volatile disk) because the user does not have to keep inputting information, since the system uses signals present in the environment to update status on packages once they are identified. Therefore, the computing system does not have to reach out to the storage device to perform a read or write operation as many times relative to existing technologies, which reduces I/O.

In any combination of the above embodiments of the computerized system, the system for identifying a package using a plurality of RFID tags comprises an RFID reading apparatus designed to read RFID tags in a scanning area, a first package including the plurality of RFID tags such that the RFID reading apparatus detects signals from the RFID tags in the package when the first package is placed in the scanning area; and a computing device communicatively coupled to the RFID reading apparatus. The computing device comprising one or more computer processors and a memory comprising instructions that when executed by one or more computer processors cause the one or more computer processors to receive a first information including first signals from the RFID tags detected at a first time using the RFID reading apparatus in the scanning area when the first package is placed in the scanning area, associate a portion of the first signals detected at the first time as belonging to the first package, and determine the identification of the first package at a second time by receiving a second information including second signals from RFID tags from a second package detected at the second time using the RFID reading apparatus, comparing a portion of the second signals detected at the second time with a portion of the associated first signals, and identifying the second package as the first package when there is an overlap between the portion of second signals detected at the second time and the portion of the associated first signals.

In any combination of the above embodiments of the computerized system, the system further comprises a label scanning device designed to scan the label of the first package and provide scanned label information to the computing device.

In any combination of the above embodiments of the computerized system, the one or more computer processors are further configured to receive the scanned label information and associate the scanned label information with the first package and the associated first signals.

In any combination of the above embodiments of the computerized system, the system further comprises a label printing device designed to receive information from the computing device and print a label for the first package.

In any combination of the above embodiments of the computerized system, the one or more computer processors are further configured to provide encoding information to the label printing device in order to encode a label for the first package by including the first information regarding the first signals in the label.

In any combination of the above embodiments of the computerized system, the one or more computer processors are further configured to receive encoded label information from encoded label of a second package scanned by the label scanning device, retrieve the associated first signals from the encoded label information, and associate the associated first signals with the second package.

In any combination of the above embodiments of the computerized system, the one or more computer processors are further configured use threshold overlap algorithms to compare the overlap in the portion of the second signals detected at the second time with the portion of the associated first signals to determine the identification of the first package at the second time.

In any combination of the above embodiments of the computerized system, the system further comprises one or more signal reading apparatus in a building designed to detect a portion of the associated first signals.

In any combination of the above embodiments of the computerized system, the system further comprises the one or more signal reading apparatus in the building are further designed to provide to the computing device information on one or more locations of the first package based on the portion of the associated first signals and use the one or more locations of the first package to determine a map of the conveyor system in the building, wherein the one or more computer processors are further configured to use the one or more locations of the first package to determine a map the movement of the first package through the building.

In any combination of the above embodiments of the computerized system, the system comprises a computing device comprising one or more computer processors and a memory comprising instructions that when executed by one or more computer processors cause the one or more computer processors to receive a first information including first signals from the two or more tags read at a first time using a signal detection apparatus, associate a portion of the first signals detected at the first time as belonging to a first package, and identifying of the first package at a second time by receiving a second information including second signals from two or more tags from a second package detected at the second time using the signal detection apparatus, comparing a portion of the second signals detected at the second time with a portion of the associated first signals, and identifying the second package as the first package at the second time when there is an overlap between the portion of the second signals detected at the second time and the portion of the associated first signals.

In any combination of the above embodiments of the computerized system, the system further comprises signal detection apparatus including an antenna designed to detect signals and provide the information to the computing device and a first package including one or more tags such that the signal detection apparatus detects signals from the tags in the package.

In any combination of the above embodiments of the computerized system, the one or more computer processors are further configured to use the one or more locations of the first package to determine a map the movement of the first package through the building.

[symbol]

### II. Apparatuses, Methods, and Systems

Embodiments of the present disclosure may be implemented in various ways, including as apparatuses that comprise articles of manufacture. An apparatus may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double information/data rate synchronous dynamic random access memory (DDR SDRAM), double information/data rate type two synchronous dynamic random access memory (DDR2 SDRAM), double information/data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices/entities, computing entities, and/or the like. As such, embodiments of the present disclosure may take the form of an apparatus, system, computing device, computing entity, and/or the like executing instructions stored on a computer-readable storage medium to perform certain steps or operations. However, embodiments of the present disclosure may also take the form of an entirely hardware embodiment performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

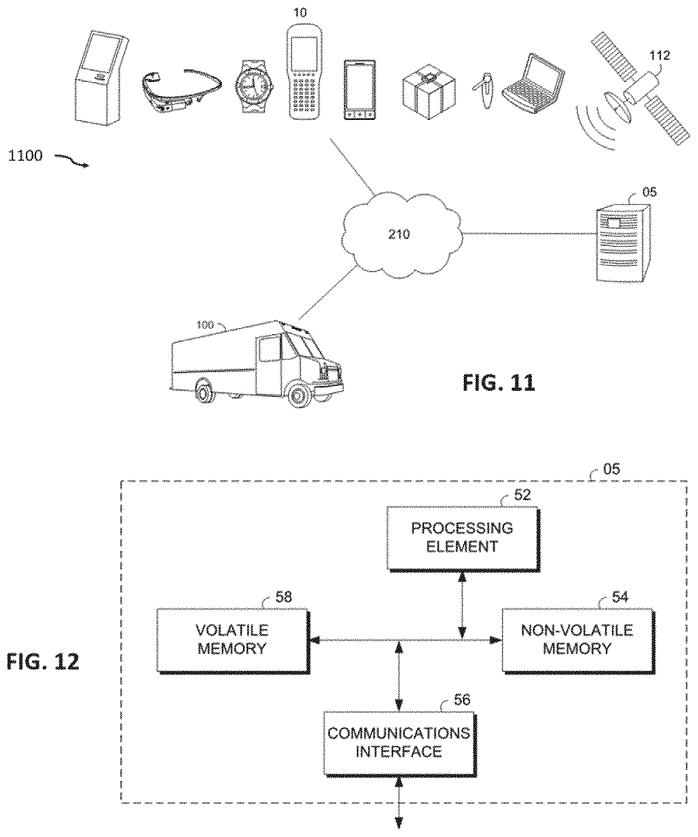

FIG. 11 is a schematic diagram of an example computing environment 1000A in which aspects of the present disclosure are employed in, according to some embodiments. As shown in FIG. 11, this particular computing environment 1000A includes one or more analysis computing entities 05, one or more computing entities 10 (e.g., a mobile devices), one or more satellites 12, one or more networks 210, and/or the like. Each of these components, entities, devices, systems, and similar words used herein interchangeably may be in direct or indirect communication with, for example, one another over the same or different wired and/or wireless networks. Additionally, while FIG. 11 illustrates the various system entities as separate, standalone entities, the various embodiments are not limited to this particular architecture. In some embodiments, the components of the system 200 are included in the environment 1000A. In some embodiments, all of the components of the system 200 are included in the one or more analysis computing entities 05. In some embodiments, all of the components of the system 200 are included in the one or more computing entities 10. In some embodiments, the components of the system 200 are distributed among both the analysis computing entity 05 and the computing entity 10.

In various embodiments, the network(s) 210 represents or includes an IoT or IoE network, which is a network of interconnected items that are each provided with unique identifiers (e.g., UIDs) and computing logic so as to communicate or transfer data with each other or other components.

FIG. 12 is a block diagram of an analysis computing entity 05, according to some embodiments. In general, the terms computing entity, computer, entity, device, system, and/or similar words used herein interchangeably may refer to, for example, one or more computers, computing entities, desktops, mobile phones, tablets, phablets, notebooks, laptops, distributed systems, consoles input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In particular embodiments, these functions, operations, and/or processes can be performed on data, content, information/data, and/or similar terms used herein interchangeably.

As indicated, in particular embodiments, the analysis computing entity 05 may also include one or more communications interfaces 56 for communicating with various computing entities, such as by communicating data, content, information/data, and/or similar terms used herein interchangeably that can be transmitted, received, operated on, processed, displayed, stored, and/or the like.

FIG. 12 is a block diagram of a computing entity 05 of FIG. 11, according to some embodiments. As shown in FIG. 12, in particular embodiments, the analysis computing entity 05 may include or be in communication with one or more processing elements 52 (also referred to as processors, processing circuitry, and/or similar terms used herein interchangeably) that communicate with other elements within the analysis computing entity 05 via a bus, for example. As will be understood, the processing element 52 may be embodied in a number of different ways. For example, the processing element 52 may be embodied as one or more complex programmable logic devices (CPLDs), microprocessors, multi-core processors, co-processing entities, application-specific instruction-set processors (ASIPs), microcontrollers, and/or controllers. Further, the processing element 04 may be embodied as one or more other processing devices or circuitry. The term circuitry may refer to an entirely hardware embodiment or a combination of hardware and computer program products. Thus, the processing element 52 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 04 may be configured for a particular use or configured to execute instructions stored in volatile or non-volatile media or otherwise accessible to the processing element 52. As such, whether configured by hardware or computer program products, or by a combination thereof, the processing element 04 may be capable of performing steps or operations according to embodiments of the present disclosure when configured accordingly.

In particular embodiments, the analysis computing entity 05 may further include or be in communication with non-volatile media (also referred to as non-volatile storage, memory, memory storage, memory circuitry and/or similar terms used herein interchangeably). In particular embodiments, the non-volatile storage or memory may include one or more non-volatile storage or memory media 54, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases (e.g., parcel/item/shipment database), database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or information/data that is stored in a computer-readable storage medium using one or more database models, such as a hierarchical database model, network model, relational model, entity-relationship model, object model, document model, semantic model, graph model, and/or the like.

In particular embodiments, the analysis computing entity 05 may further include or be in communication with volatile media 58 (also referred to as volatile storage, memory, memory storage, memory circuitry and/or similar terms used herein interchangeably). In particular embodiments, the volatile storage or memory may also include one or more volatile storage or memory media 58, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 52. Thus, the databases, database instances, database management systems, data, applications, programs, program modules, scripts, source code, object code, byte code, compiled code, interpreted code, machine code, executable instructions, and/or the like may be used to control certain aspects of the operation of the analysis computing entity 05 with the assistance of the processing element 52 and operating system.

As indicated, in particular embodiments, the analysis computing entity 05 may also include one or more communications interfaces 56 for communicating with various computing entities, such as by communicating information/data, content, information/data, and/or similar terms used herein interchangeably that can be transmitted, received, operated on, processed, displayed, stored, and/or the like. Such communication may be executed using a wired information/data transmission protocol, such as fiber distributed information/data interface (FDDI), digital subscriber line (DSL), Ethernet, asynchronous transfer mode (ATM), frame relay, information/data over cable service interface specification (DOCSIS), or any other wired transmission protocol. Similarly, the analysis computing entity 05 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, long range low power (LoRa), LTE Cat M1, NarrowBand IoT (NB IoT), and/or any other wireless protocol.

Although not shown, the analysis computing entity 05 may include or be in communication with one or more input elements, such as a keyboard input, a mouse input, a touch screen/display input, motion input, movement input, audio input, pointing device input, joystick input, keypad input, and/or the like. The analysis computing entity 05 may also include or be in communication with one or more output elements (not shown), such as audio output, video output, screen/display output, motion output, movement output, and/or the like.

As will be appreciated, one or more of the analysis computing entity's 05 components may be located remotely from other analysis computing entity 05 components, such as in a distributed system. Additionally or alternatively, the analysis computing entity 05 may be represented among a plurality of analysis computing entities. For example, the analysis computing entity 05 can be or be included in a cloud computing environment, which includes a network-based, distributed/data processing system that provides one or more cloud computing services. Further, a cloud computing environment can include many computers, hundreds or thousands of them or more, disposed within one or more data centers and configured to share resources over the network(s) 210. Furthermore, one or more of the components may be combined and additional components performing functions described herein may be included in the analysis computing entity 05. Thus, the analysis computing entity 05 can be adapted to accommodate a variety of needs and circumstances. As will be recognized, these architectures and descriptions are provided for exemplary purposes only and are not limiting to the various embodiments.

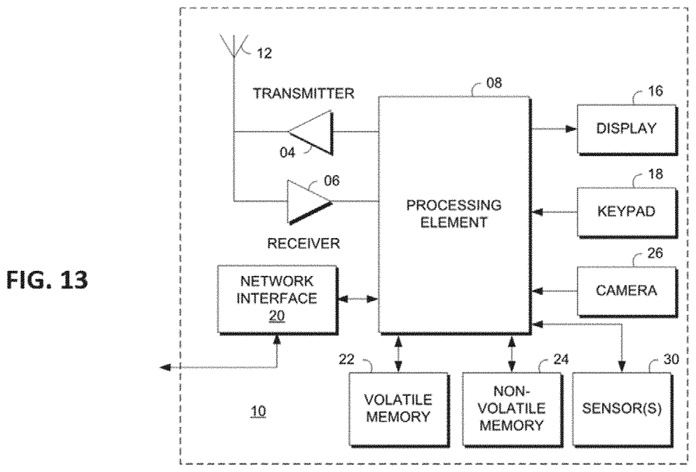

FIG. 13 is a block diagram of a computing entity 10 of FIG. 11, according to some embodiments. In certain embodiments, computing entities 10 may be embodied as handheld computing entities, such as mobile phones, tablets, personal digital assistants, and/or the like, that may be operated at least in part based on user input received from a user via an input mechanism. Moreover, computing entities 10 may be embodied as onboard vehicle computing entities, such as central vehicle electronic control units (ECUs), onboard multimedia system, and/or the like that may be operated at least in part based on user input. Such onboard vehicle computing entities may be configured for autonomous and/or nearly autonomous operation however, as they may be embodied as onboard control systems for autonomous or semi-autonomous vehicles, such as unmanned aerial vehicles (UAVs), robots, and/or the like. As a specific example, computing entities 10 may be utilized as onboard controllers for UAVs configured for picking-up and/or delivering packages to various locations, and accordingly such computing entities 10 may be configured to monitor various inputs (e.g., from various sensors) and generated various outputs. It should be understood that various embodiments of the present disclosure may comprise a plurality of computing entities 10 embodied in one or more forms (e.g., parcel security devices kiosks, mobile devices, watches, laptops, carrier personnel devices (e.g., Delivery Information Acquisition Devices (DIAD)), etc.)

As will be recognized, a user may be an individual, a family, a company, an organization, an entity, a department within an organization, a representative of an organization and/or person, and/or the like—whether or not associated with a carrier. In particular embodiments, a user may operate a computing entity 10 that may include one or more components that are functionally similar to those of the analysis computing entity 05. FIG. 13 provides an illustrative schematic representative of a computing entity 10 that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, vehicle multimedia systems, autonomous vehicle onboard control systems, watches, glasses, key fobs, radio frequency identification (RFID) tags, ear pieces, scanners, imaging devices/cameras (e.g., part of a multi-view image capture system), wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Computing entities 10 can be operated by various parties, including carrier personnel (sorters, loaders, delivery drivers, network administrators, and/or the like). As shown in FIG. 13, the computing entity 10 can include an antenna 12, a transmitter 04A (e.g., radio), a receiver 06 (e.g., radio), and a processing element 08 (e.g., CPLDs, microprocessors, multi-core processors, coprocessing entities, ASIPs, microcontrollers, and/or controllers) that provides signals to and receives signals from the transmitter 04A and receiver 06, respectively. In some embodiments, the computing entity 10 includes one or more sensors 30. In this way, in some embodiments, the computing entity 10 is a special-purpose computer or particular machine. The one or more sensors 30 can be one or more of: a pressure sensor, an accelerometer, a gyroscope, a geolocation sensor (e.g., GPS sensor), a radar, a LIDAR, sonar, ultrasound, an object recognition camera, and any other suitable sensor described herein to map a loading area.

The signals provided to and received from the transmitter 04A and the receiver 06, respectively, may include signaling information in accordance with air interface standards of applicable wireless systems. In this regard, the computing entity 10 may be capable of operating with one or more air interface standards, communication protocols, modulation types, and access types. More particularly, the computing entity 10 may operate in accordance with any of a number of wireless communication standards and protocols, such as those described above with regard to the analysis computing entity 05. In a particular embodiment, the computing entity 10 may operate in accordance with multiple wireless communication standards and protocols, such as UMTS, CDMA2000, 1xRTT, WCDMA, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the computing entity 10 may operate in accordance with multiple wired communication standards and protocols, such as those described above with regard to the analysis computing entity 05 via a network interface 20.

Via these communication standards and protocols, the computing entity 10 can communicate with various other entities using concepts such as Unstructured Supplementary Service information/data (US SD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

According to particular embodiments, the computing entity 10 may include location determining aspects, devices, modules, functionalities, and/or similar words used herein interchangeably. For example, the computing entity 10 may include outdoor positioning aspects, such as a location module adapted to acquire, for example, latitude, longitude, altitude, geocode, course, direction, heading, speed, universal time (UTC), date, and/or various other information/data. In particular embodiments, the location module can acquire information/data, sometimes known as ephemeris information/data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This information/data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information can be determined by triangulating the computing entity's 10 position in connection with a variety of other systems, including cellular towers, Wi-Fi access points, and/or the like. Similarly, the computing entity 10 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices/entities (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The computing entity 10 may also comprise a user interface (that can include a display 16 coupled to a processing element 08) and/or a user input interface (coupled to a processing element 08). For example, the user interface may be a user application, browser, user interface, and/or similar words used herein interchangeably executing on and/or accessible via the computing entity 10 to interact with and/or cause display of information from the analysis computing entity 05, as described herein. The user input interface can comprise any of a number of devices or interfaces allowing the computing entity 10 to receive information/data, such as a keypad 318 (hard or soft), a touch display, voice/speech or motion interfaces, or other input device. In embodiments including a keypad 18, the keypad 18 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

As shown in FIG. 13, the computing entity 10 may also include a camera, imaging device, and/or similar words used herein interchangeably 26 (e.g., still-image camera, video camera, IoT enabled camera, IoT module with a low resolution camera, a wireless enabled MCU, and/or the like) configured to capture images. The computing entity 10 may be configured to capture images via the onboard camera 26, and to store those imaging devices/cameras locally, such as in the volatile memory 22 and/or non-volatile memory 24. As discussed herein, the computing entity 10 may be further configured to match the captured image data with relevant location and/or time information captured via the location determining aspects to provide contextual information/data, such as a time-stamp, date-stamp, location-stamp, and/or the like to the image data reflective of the time, date, and/or location at which the image data was captured via the camera 26. The contextual data may be stored as a portion of the image (such that a visual representation of the image data includes the contextual data) and/or may be stored as metadata (e.g., data that describes other data, such as describing a payload) associated with the image data that may be accessible to various computing entities 10.

The computing entity 10 may include other input mechanisms, such as scanners (e.g., barcode scanners), microphones, accelerometers, RFID readers, and/or the like configured to capture and store various information types for the computing entity 10. For example, a scanner may be used to capture parcel/item/shipment information/data from an item indicator disposed on a surface of a shipment or other item. In certain embodiments, the computing entity 10 may be configured to associate any captured input information/data, for example, via the onboard processing element 08. For example, scan data captured via a scanner may be associated with image data captured via the camera 26 such that the scan data is provided as contextual data associated with the image data.

The computing entity 10 can also include volatile storage or memory 22 and/or non-volatile storage or memory 24, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, information/data, applications, programs, program modules, scripts, source code, object code, byte code, compiled code, interpreted code, machine code, executable instructions, and/or the like to implement the functions of the computing entity 10. As indicated, this may include a user application that is resident on the entity or accessible through a browser or other user interface for communicating with the analysis computing entity 05 and/or various other computing entities.

In another embodiment, the computing entity 10 may include one or more components or functionality that are the same or similar to those of the analysis computing entity 05, as described in greater detail above. As will be recognized, these architectures and descriptions are provided for exemplary purposes only and are not limiting to the various embodiments.

The term “user” described herein may refer to a human user, a robot, an artificial intelligence entity, or a program, such as a service.

What is claimed is:

1. A system for identifying a package using a plurality of radio-frequency identification (RFID) tags, comprising:
an RFID reading apparatus designed to read RFID tags in a scanning area;
a first package including the plurality of RFID tags such that the RFID reading apparatus detects signals from the RFID tags in the package when the first package is placed in the scanning area; and
a computing device communicatively coupled to the RFID reading apparatus, the computing device comprising one or more computer processors and a memory comprising instructions that when executed by one or more computer processors cause the one or more computer processors to:
receive a first information including first signals from the RFID tags detected at a first time using the RFID reading apparatus in the scanning area when the first package is placed in the scanning area;
associate a portion of the first signals detected at the first time as belonging to the first package; and
determine the identification of the first package at a second time by:
receiving a second information including second signals from RFID tags from a second package detected at the second time using the RFID reading apparatus;
comparing a portion of the second signals detected at the second time with a portion of the associated first signals; and
identifying the second package as the first package when there is an overlap between the portion of second signals detected at the second time and the portion of the associated first signals.

2. The system of claim 1, further comprising a label scanning device designed to scan the label of the first package and provide scanned label information to the computing device;

3. The system of claim 2, wherein the one or more computer processors are further configured to receive the scanned label information and associate the scanned label information with the first package and the associated first signals.

4. The system of claim 3, further comprising a label printing device designed to receive information from the computing device and print a label for the first package.

5. The system of claim 4, wherein the one or more computer processors are further configured to provide encoding information to the label printing device in order to encode a label for the first package by including the first information regarding the first signals in the label.

6. The system of claim 5, wherein the one or more computer processors are further configured to:
receive encoded label information from encoded label of a second package scanned by the label scanning device;
retrieve the associated first signals from the encoded label information; and
associate the associated first signals with the second package.

7. The system of claim 1, wherein the one or more computer processors are further configured to use threshold overlap algorithms to compare the overlap in the portion of the second signals detected at the second time with the portion of the associated first signals to determine the identification of the first package at the second time.

8. The system of claim 1, further comprising one or more signal reading apparatus in a building designed to detect a portion of the associated first signals.

9. The system of claim 8, further comprising the one or more signal reading apparatus in the building are further designed to provide to the computing device information on one or more locations of the first package based on the portion of the associated first signals and use the one or more locations of the first package to determine a map of the conveyor system in the building, wherein the one or more computer processors are further configured to use the one or more locations of the first package to determine a map the movement of the first package through the building.

10. The system of claim 1, wherein the plurality of RFID tags are associated with at least one of following: one or more items in the package, one or more labels on the package, one or more packaging in the package, one or more materials contained in the package.

11. The system of claim 1, wherein the first package includes an RFID tag.

12. A method comprising:
receiving a first information including first signals from a plurality of RFID tags read at a first time using an RFID reading apparatus in a scanning area when a package is placed in the scanning area;
associating a portion of the first signals detected at the first time as belonging to a first package; and
determining the identification of the first package at a second time by:
receiving a second information including second signals from RFID tags from a second package read at a second time using the RFID reading apparatus;
comparing a portion of the second signals detected at the second time with a portion of the first signals; and
identifying the second package as the first package when there is an overlap between the portion of the second signals detected at the second time and the portion of the first signals.

13. The method of claim 12, further comprising:
scanning label information from the first package using a label scanning device; and
associating the scanned label information with the first package and the first signals.

14. The method of claim 13, further comprising:
receiving encoded label information from encoded label of a second package scanned by the label scanning device;
retrieving the associated first signals from the encoded label information; and
associating the associated first signals with the second package.

15. The method of claim 12, further comprising:
providing encoding information to the label printing device to encode a label for the package by including information about the associated first signals in the label.

16. The method of claim 12, further comprising using threshold overlap algorithms to compare the overlap in the portion of the second signals detected at the second time with the portion of the associated first signals to determine the identification of the first package at the second time.

17. The method of claim 12, further comprising:
determining location of the first package based on information of a portion of the associated first signals detected using one or more signal reading apparatus;
determining a map of the conveyor system in the building using one or more locations of the first package from the one or more signal reading apparatus; and
determining the map of the building using one or more locations of the first package from the one or more signal reading apparatus.

18. A system for identifying a package, comprising:
a computing device comprising one or more computer processors and a memory comprising instructions that when executed by one or more computer processors cause the one or more computer processors to:
receive a first information including first signals from the two or more tags read at a first time using a signal detection apparatus;
associate a portion of the first signals detected at the first time as belonging to a first package; and
identifying of the first package at a second time by:
receiving a second information including second signals from two or more tags from a second package detected at the second time using the signal detection apparatus;
comparing a portion of the second signals detected at the second time with a portion of the associated first signals; and
identifying the second package as the first package at the second time when there is an overlap between the portion of the second signals detected at the second time and the portion of the associated first signals.

19. The system of claim 18, further comprising:
the signal detection apparatus including an antenna designed to detect signals and provide the information to the computing device; and
a first package including one or more tags such that the signal detection apparatus detects signals from the tags in the package.

20. The system of claim 18, wherein the one or more computer processors are further configured to use the one or more locations of the first package to determine a map the movement of the first package through the building.
